(19) United States
(12) Patent Application Publication
(10) Pub. No.: US 2003/0033465 A1
(43) Pub. Date: Feb. 13, 2003

(54) Hot-swap device applicable to ATA interface

(76) Inventors: Cheng-Chih Chien, Taichung (TW); Being-Fei Wu, Hsinchu (TW); Jou-Wei Fu, Hsinchu (TW); Lung-Yi Kuo, Ta-Chia Town (TW); Sheng-I Hsu, Yuan-Lin Town (TW); Chung-Chi Tien, Taichung (TW)

Correspondence Address: SUPREME PATENT SERVICES, POST OFFICE BOX 2339, SARATOGA, CA, 95070, US

(21) Appl. No.: 09/924,916

(22) Filed: Aug. 8, 2001

(51) Int. Cl. G06F 13/38

(52) U.S. Cl. 710/302

(57) ABSTRACT

A hot-swap device applicable to the ATA interface comprises at least an integrated drive electronics (IDE) hard disk drive controller for processing IDE instructions transferred from the ATA interface, wherein at least a program code is provided to the IDE hard disk drive controller for the same to execute and respond to the ATA interface “a virtual storage device” in the case of lacking a real storage device connected to the IDE hard disk drive controller directly or via the ATA interface, or if a “real storage device” is connected with the IDE hard disk drive directly or via the ATA interface, the ATA interface will receive response from the “real storage device”.

### FIELD OF THE INVENTION

This invention relates generally to hot-swap devices applicable to the known integrated drive electronics (IDE) bus, more particularly, it relates to a hot-swap device applicable to the conventional IDE bus without changing the standard driver.

### BACKGROUND OF THE INVENTION

A conventional IDE bus usually doesn't support the hot-swap function, meanwhile, the standard driver cannot sense any change of a storage hardware via the IDE bus. Therefore, for performance of the hot-swap function through the conventional IDE bus in this case, an extra nonstandard driver is needed for scanning the IDE bus back and forth trying to find out if any new storage device is joined. However, under such a situation, the standard driver must be substituted by the nonstandard one that would probably deteriorate the compatibility in the computer system.

When change of the storage hardware cannot be detected through the IDE bus by a computer operating system (OS), troubles may come up as the following:

(a) Should OS have failed in detecting a storage device on the IDE bus when booting, then it wouldn't be able to find out any newly joined storage hardware thereinafter, a hard disk drive for example.

(b) When OS instructs to read or write through the IDE bus in the case of lacking any storage hardware, the situation becomes unexpectable to result in, for example, a “system down” the worst.

In view of the abovesaid, this invention is to provide a feasible way that performs the hot-swap function via a conventional IDE bus without changing the standard driver.

### SUMMARY OF THE INVENTION

The primary object of this invention is to provide a hot-swap device that supports the hot-swap function via a conventional IDE bus without changing the standard driver.

Another object of this invention is to provide a hot-swap device applicable to a PCMCIA/CF (Personal Computer Memory Card International Association/Compact Flash) interface.

In order to realize abovesaid object, the hot-swap device of this invention applicable to the ATA (AT Attachment) interface should comprise at least an IDE hard disk drive (HDD) controller for processing IDE instructions transferred from the ATA interface, wherein at least a program code is provided to the IDE hard disk drive controller to respond to the ATA interface “a virtual storage device” in the case of lacking a real storage device connected to the IDE HDD controller via the ATA interface, or if the program code is executed to connect “a real storage device” to the IDE HDD controller via the ATA interface, connection of the IDE HDD controller with the ATA interface is disabled so that the real storage device will respond to the ATA interface directly.

Moreover, the hot-swap device of this invention applicable to the ATA (AT Attachment) interface should comprise at least an IDE hard disk drive (HDD) controller for processing IDE instructions transferred from the ATA interface, wherein at least a program code is provided to the IDE hard disk drive controller for the same to execute and respond to the ATA interface “a virtual storage device” in the case of lacking a real storage device, or respond to the ATA interface “a real storage device” if the program code is executed to connect the real storage device with the IDE HDD controller.

For more detailed information regarding advantages or features of this invention, at least an example of preferred embodiment will be elucidated below with reference to the annexed drawings.

### BRIEF DESCRIPTION OF THE DRAWINGS

FIG. 1 shows a first embodiment of this invention.

FIGS. 2A and 2B show a second embodiment of this invention.

FIG. 3 is a flowchart of this invention.

FIG. 4 shows an embodiment of virtual ID table.

FIG. 5 shows an embodiment of virtual partition table.

### DETAILED DESCRIPTION OF THE INVENTION

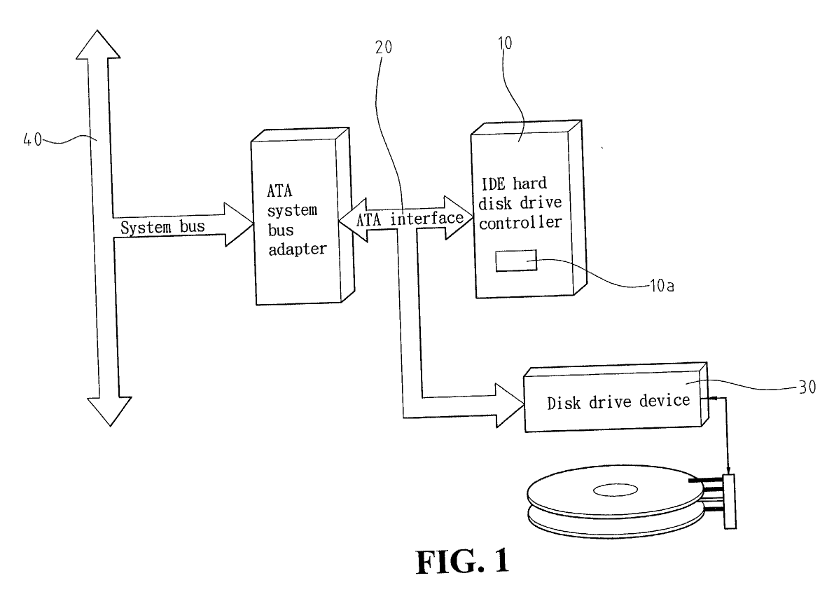

As shown in FIG. 1—a first embodiment of this invention-the IDE (integrated drive electronics) hard disk drive (HDD) controller 10 of a hot-swap device is coupled with an ATA (AT Attachment) interface 20, which is connected with a disk drive device 30 and a system bus 40 respectively. A memory 10a of the IDE hard disk drive (HDD) controller 10 is provided at least with a program code for the IDE hard disk drive controller 10 to run and respond to the ATA interface 20 “a virtual storage device” in the case of lacking a real storage device connected to the IDE HDD controller, for example the disk drive device 30, or when the program code is executed to connect the “real storage device” with the IDE HDD controller 10 via the ATA interface, connection between the IDE HDD 10 and the ATA interface 20 is disabled while the “real storage device” will respond directly to the ATA interface instead.

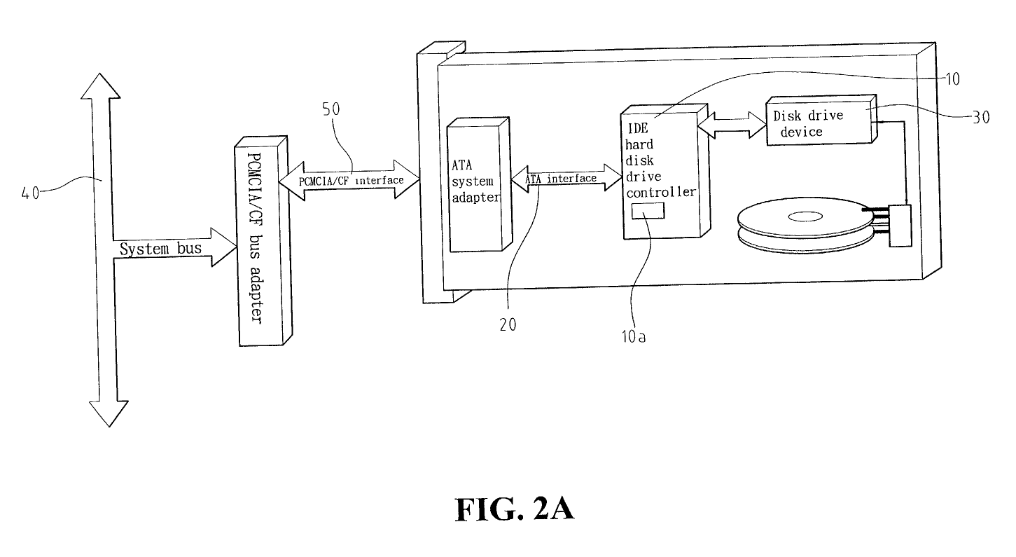

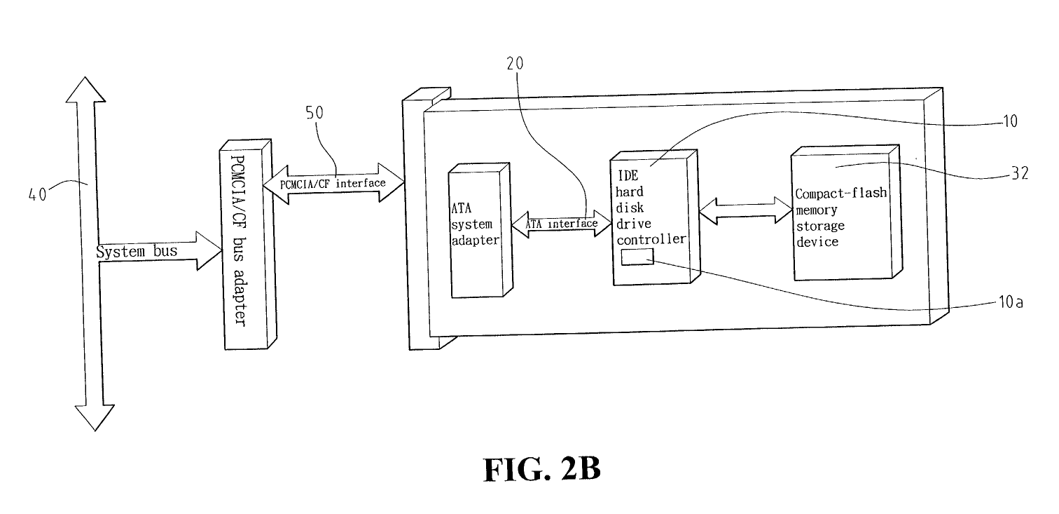

FIGS. 2A and 2B show a second embodiment of this invention. In FIG. 2A, the IDE hard disk drive controller 10 of the hot-swap device is coupled with the ATA (AT Attachment) interface 20 and the disk drive device 30 while the IDE hard disk drive controller 10 of the hot-swap device in FIG. 2B is coupled with the ATA interface 20 and a compact-flash storage device 32 respectively, wherein the ATA interface 20 is coupled with a PCMCIA/CF interface 50 connected with the system bus 40. The memory 10a of the IDE hard disk drive controller 10 is provided at least with a program code for the IDE hard disk drive controller 10 to run and respond to the ATA interface 20 “a virtual storage device” in the case of lacking a real storage device, for example the disk drive device 30 or the compact-flash storage device 32 connected to the controller, or “a real storage device” otherwise.

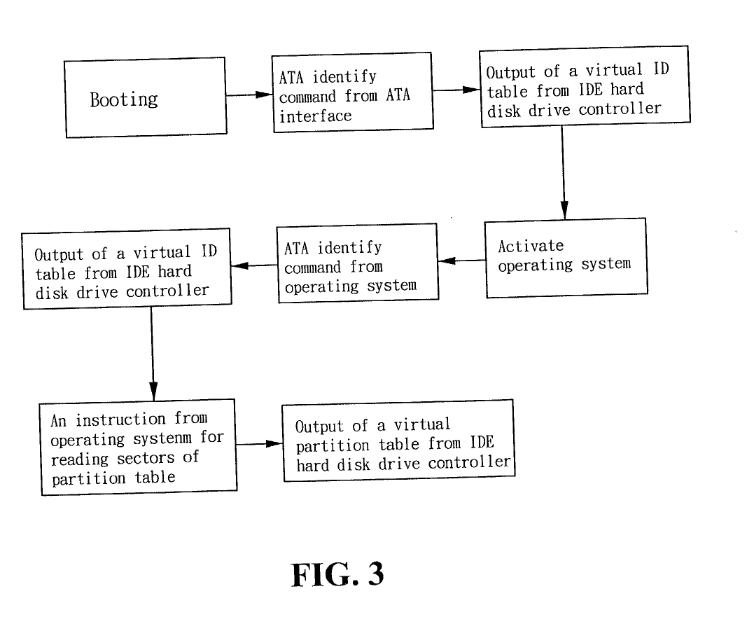

In a flowchart shown in FIG. 3, the IDE hard disk drive controller 10 is operated without connecting with any real storage device mentioned above. When booting a computer, the system bus 40 is supposed to deliver an ATA identify command (one of the IDE instructions) to the IDE hard disk drive controller 10 via the ATA interface 20 or via the PCMCIA/CF interface 50, then the ATA interface 20, and the IDE hard disk drive controller 10 would run the program code now for output of a virtual ID (identifier) table 60. When the operating system is activated, it is supposed to send out an ATA identify command to the IDE hard disk drive controller 10, which in turn runs the program code for output of the virtual ID table 60. Now, the operating system commands the IDE hard disk drive controller 10 to run the program code to read sectors of a partition table and give a virtual partition table 70.

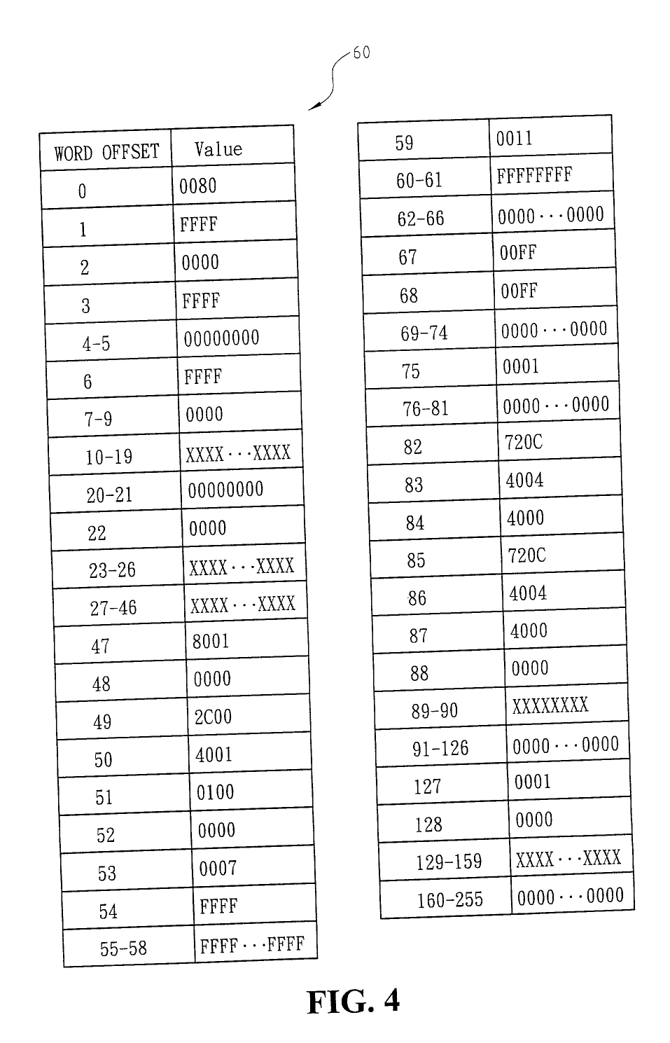

FIG. 4 shows an embodiment of virtual ID table—a promulgated industrial standard already put into practice. A virtual ID table 60 shown in FIG. 4 is an embodiment cooperative with the hot-swap device of this invention under standard industrial regulations, wherein all the related numerals have been defined in hexadecimal codes for realizing a virtual storage device.

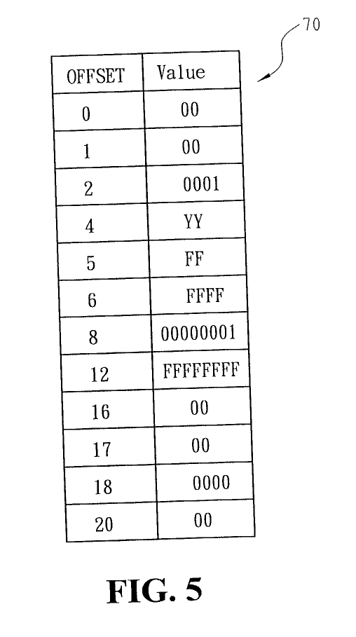

FIG. 5 shows an embodiment of virtual partition table—also a promulgated industrial standard already put into practice. A virtual partition table 70 shown in FIG. 5 is an embodiment cooperative with the hot-swap device of this invention under standard industrial regulations, wherein all the related numerals have been defined in hexadecimal codes for realizing a virtual storage device. Offset 4 in value “YY” of the virtual partition table 70 represents a partition mode on account of a practical application, wherein 00, 06, 0B, 0C, and 0F represent a partition mode of “Unknown”, “FAT 16”, “FAT 32”, “FAT 32 28. 4G”, and “Extend FAT 32” respectively.

In order to fetch a correct address every time the operating system is to read or write, this invention takes the advantage of a specialty of the operating system, that is, the operating system will rearrange the structure of the file system when a real HDD is newly added to a computer system equipped with no HDD-like storage device before. For working together in cooperation with the specialty of operating system, when the HDD controller 10 runs to read the sectors of a virtual storage device, all the data in those sectors is responded with “0” except sector 0 that includes output of a virtual partition table 70, so that the operating system will admit the existence of a virtual storage device which is not yet formatted. And after the real storage device of a new HDD is added, the operating system will read the sectors of the new HDD once more for updating, and for assuring normal operation of an instruction, the operating system must have set the “attribute” of the HDD as “portable” in order to avoid delay of data-writing.

In the above described, at least one preferred embodiment has been described in detail with reference to the drawings annexed, and it is apparent that numerous variations or modifications may be made without departing from the true spirit and scope thereof, as set forth in the claims below.

What is claimed is:

1. A hot-swap device applicable to the ATA (AT Attachment) interface, comprising at least an IDE hard disk drive (HDD) controller for processing IDE instructions transferred from the ATA interface, wherein at least a program code is provided to the IDE hard disk drive controller to respond to the ATA interface “a virtual storage device” in the case of lacking a real storage device connected to the IDE HDD controller via the ATA interface, or if the program code is executed to connect “a real storage device” to the IDE HDD controller via the ATA interface, connection of the IDE HDD controller with the ATA interface is disabled so that the real storage device will respond to the ATA interface directly.

2. The hot-swap device according to claim 1, wherein the program code for output of “a virtual storage device” to the ATA interface is run by the IDE hard disk drive controller to effect output of a virtual identifier (ID) table and a virtual partition table to the ATA interface.

3. A hot-swap device applicable to the ATA (AT Attachment) interface, comprising an integrated drive electronics (IDE) hard disk device controller for processing IDE instructions transferred from the ATA interface, wherein at least a program code is provided to the IDE hard disk drive controller for the same to execute and respond to the ATA interface “a virtual storage device” in the case of lacking a real storage device connected to the IDE hard disk drive controller, or respond to the ATA interface “a real storage device” if the program code is executed to connect a “real storage device” with the IDE hard disk drive.

4. The hot-swap device according to claim 3, wherein the real storage device is a compact-flash memory storage device.

5. The hot-swap device according to claim 3, wherein the program code for output of “a virtual storage device” to the ATA interface is run by the IDE hard disk drive controller to effect output of a virtual identifier (ID) table and a virtual partition table to the ATA interface.
